(19) United States
(12) Patent Application Publication
(10) Pub. No.: US 2003/0009976 A1
(43) Pub. Date: Jan. 16, 2003

(54) Wood and metal raised panel decorative structure and method of production

(76) Inventors: Maurizio Hauser, Tel-Aviv (IL); Alberto Manevich, Tel-Aviv (IL)

Correspondence Address: Edward Langer, Pat. Atty., c/o Landon & Stark Associates, One Crystal Park, Suite 210, 2011 Crystal Drive, Arlington, VA, 22202, US

(21) Appl. No.: 09/901,019

(22) Filed: Jul. 10, 2001

(51) Int. Cl. E06B 3/32

(52) U.S. Cl. 52/656.4; 52/455

(57) ABSTRACT

A decorative structure having the aesthetic advantages of a wooden raised panel-style appearance, which can be efficiently and accurately produced, and which includes metal layers to increase durability, security, fire-resistance, sound and thermal insulation and to decrease warpage. The structure comprises an innermost layer of a rigid material, a metal layer, preferably of aluminum, fixedly attached to each side of the innermost layer, and an outer wooden layer fixedly attached to the outer surface of each metal layer. One or both of the metal layers are at least partially exposed by patterned cutting of channels in one or both of the outer wooden layers using a standard router having a cutting bit, according to a desired pattern. The channels may be in the form of straight lines, curves, numbers, letters or specific designs. In a preferred embodiment, the structure comprises a door. Alternative embodiments include wall panels, table tops and other furniture items.

### FIELD OF THE INVENTION

The present invention relates to layered metal and wood structures, and more particularly to a wood-surfaced, raised panel-style structure having inner metal layers.

### BACKGROUND OF THE INVENTION

The most common types of entry door are the flush variety and the raised panel-style door. The flush door may be constructed of plywood or a steel skin placed over a perimeter frame. A conventional panel door comprises stiles and rails extending vertically and horizontally in the door. The rectangular spaces within the perimeter of these stiles and rails are filled by panels having tapered, marginal edges seated in grooves provided by the stiles and rails. The stiles and rails must be arranged with great accuracy, and the entire process is time and labor intensive.

The raised panel-style door is generally more popular on the grounds of aesthetic considerations. Panels may be attached to a flush door to give it a raised panel appearance, which involves considerable accuracy of work and is time and labor consuming.

Conventional doors of both types have a number of disadvantages, such as poor fire-resistance, poor sound insulation, and poor thermal insulation. The door is subject to warpage due to temperature differentials across the door and due to moisture absorption by the door.

Raised panel doors also have the disadvantages of low durability and poor security protection. Under the stress of normal use and the passage of time, the stiles and rails tend to sag, warp, split and separate from each other with loosening of the panels which they encompass. Poor security protection is offered since the panels can be broken out for the purpose of breaking through the door.

Many types of wood doors have been developed with improved thermal insulation properties, frequently involving an insulative foam core. Although these doors provide improved thermal insulation, they are not fire-retardant.

A number of doors having fire retardant features have been described, employing a fire-retardant core or using fire-retardant chemicals. Other doors have been designed to provide sound insulation. However, it has generally been found that doors designed to have increased fire-retardant properties do not provide good sound insulation, and vice versa.

The inclusion of a metal core in a wooden door would overcome many of the above problems. A door has been described by Hugus et al. (U.S. Pat. No. 6,112,496) having two metal panels, covered by wood panels, which provides tolerance to fire and noise attenuation. This design produces a flat outer wooden surface, and does not provide the attractive appearance of the panel-style door.

Costello (U.S. Pat. No. 5,438,808) describes a wood-surfaced door provided with a metal core, which contributes high structural strength, non-warping and fire-resistance characteristics. Panels of wood are adhesively attached to the metal core to give a pleasing panel-style appearance, which is time and labor consuming.

Hagemeyer (U.S. Pat. No. 4,630,470) describes a thermal and moisture resistant door comprising a perimeter framework with a laminated skin, including an aluminum vapor barrier layer. Again, this is a flush door, and therefore of less attractive appearance than a raised panel door.

Therefore it would be desirable to provide a door which can be efficiently and accurately produced, having the safety and durability advantages of a wood-metal door, and the attractive appearance of a raised panel door.

### SUMMARY OF THE INVENTION

Accordingly, it is an object of the present invention to overcome the disadvantages of the prior art and provide a structure having the aesthetic advantages of a raised panel-style appearance, which is efficiently and accurately produced, and which includes metal layers to increase durability, security, fire-resistance, sound and thermal insulation and to decrease warpage.

In accordance with a preferred embodiment of the present invention, there is provided a wood and metal structure comprising an interior wooden layer having a front surface and a back surface; a pair of metal layers each having an inner surface and an outer surface, each of said inner surfaces being adhesively attached to an opposite one of said surfaces of said interior wooden layer; a pair of exterior wooden layers, each of said wooden layers being adhesively attached to said outer surface of one of said metal layers; wherein at least a portion of a front face of the door has said inner metal layer at least partially exposed by patterned cutting of channels in said wooden exterior layer.

A feature of the present invention is that the panels may be accurately and efficiently manufactured.

An additional feature of the present invention is that an aesthetic appearance is produced.

According to a preferred embodiment, there is provided a raised panel, composite wood and metal door having increased safety and durability factors.

An advantage of the present invention is that the door is fire-resistant.

A further advantage of the present invention is that the door provides sound insulation.

A further advantage of the present invention is that the door provides thermal insulation.

A further advantage of the present invention is that the door has a low tendency to warp.

A further advantage of the present invention is that the door has high durability.

A further advantage of the present invention is that the door offers good security protection.

Additional features and advantages of the invention will become apparent from the following drawings and description.

### BRIEF DESCRIPTION OF THE DRAWINGS

For a better understanding of the invention with regard to the embodiments thereof, reference is made to the accompanying drawings, in which like numerals designate corresponding sections or elements throughout, and in which:

FIG. 1a shows an exploded perspective view of a layered wood and metal door of the present invention;

Fig. 1b shows a perspective view of a cutting tool applied to the outer surface of the door;

FIG. 1c shows a perspective view of a raised panel door constructed in accordance with the present invention;

FIGS. 2a and 2b show perspective and side views, respectively of a panel of the structure of the present invention;

FIGS. 3a and 3b show perspective and side views, respectively of a panel of an alternative embodiment of the structure of the present invention;

FIGS. 4a and 4b show perspective and side views, respectively, of a panel of a further alternative embodiment of the structure of the present invention; and

FIG. 5 shows a side view of a series of panels of the present invention.

### DETAILED DESCRIPTION OF THE PREFERRED EMBODIMENTS.

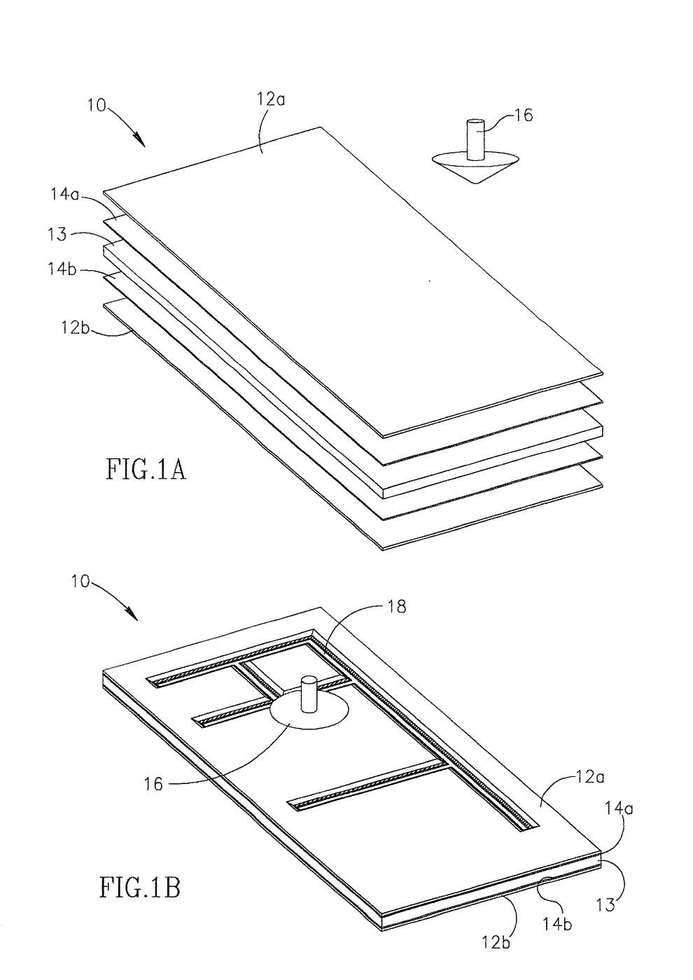

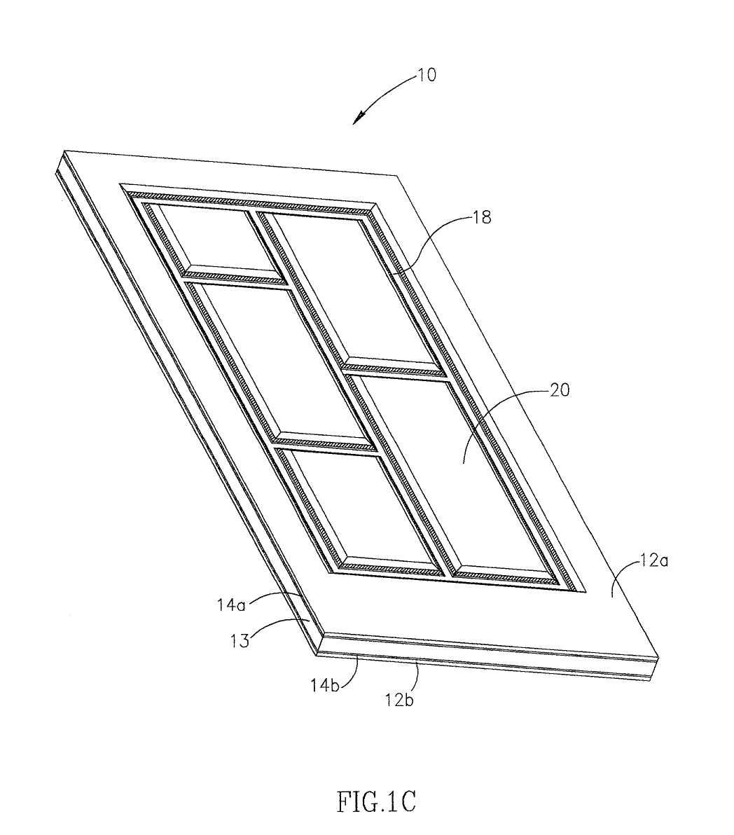

Reference is now made to FIGS. 1a-c, which illustrate a door 10, constructed in accordance with the principles of the present invention.

It should be understood that although the present invention is described with regard to a door, the principles of the invention may be applied to a wide variety of structures which can be constructed by combining the durability and other advantages of a metal layer with the aesthetic advantages of a wooden raised-panel surface. Examples of such structures include wall panels, table tops and other furniture items.

In accordance with the principles of the present invention, door 10 is provided with wood and metal layers, generally planar in structure, such that outer layers 12a and 12b are formed from wood and inner layers 14a and 14b are formed from metal, with inner metal layers 14a and 14b separated from each other by an inner wooden layer 13. Layer 13 may comprise a single solid layer, or a number of sublayers.

The principles of the invention may also be applied to a structure comprising only one inner metal layer. In the case of a door or similar structure in which both outer layers will be visible, the metal layer should be covered by two wooden layers to maintain the aesthetic properties. Channels may be formed in the door from both sides, but should only penetrate the wooden layers, or a minimal depth of the metal layer, in order to maintain the integrity of the structure.

In the case of a structure such as a table top or wall panel, in which only one decorative outer surface is required, a single wooden layer may be used. A wall panel may comprise a metal layer, to be fixedly attached to the wall, covered by an outer wooden layer in which channels are formed. A table top or other item of furniture may be formed with a second outer layer which would form the underside of the table and not generally be seen, which therefore does not need to have an attractive appearance. This may be of wood, plywood, or other rigid material.

The layers are fixedly attached one to the other by standard gluing methods. In a preferred embodiment, the metal layer is formed from aluminum. Alternatively, metal layers 14a and/or 14b may be formed from a different metal, such as brass, which can be cut by a standard router having a cutting bit.

As shown in Fig. 1b, a standard router having a cutting bit 16 is used to cut channels 18 in front-facing outer wood layer 12a, such that metal layer 14a is exposed. Cutting bit 16 should preferably be controlled by a CNC (computerized numerical control) work station (not shown). Alternatively, bit 16 may be provided as part of a manual cutting system (not shown) which is typically arranged with a jig or other tool for guidance of the cutting system in order that uniform depth and thickness are maintained along the length of the cut.

A second set of channels may be formed in the back-facing outer wooden layer 12b, or alternatively, layer 12b may be left intact.

Referring now to FIG. 1c, an embodiment of a door 10 is shown, constructed in accordance with the principles of the present invention. Channels 18 are cut in a desired pattern in outer wooden layer 12a so as to expose metal layer 14a. The regions 20 of outer surface 12a which are defined by the boundaries of channels 18 form raised wooden panels between channels 18.

The resulting product is a raised panel door of attractive appearance, each panel being framed by a metal edge. The metal may be polished so as to be light-reflective and enhance the aesthetic features of the door.

A finishing layer of clear coating such as lacquer may be applied, if desired.

The principles of the present invention may be applied to a variety of decorative structures, such as table-tops and other furniture surfaces, wall panels and flooring.

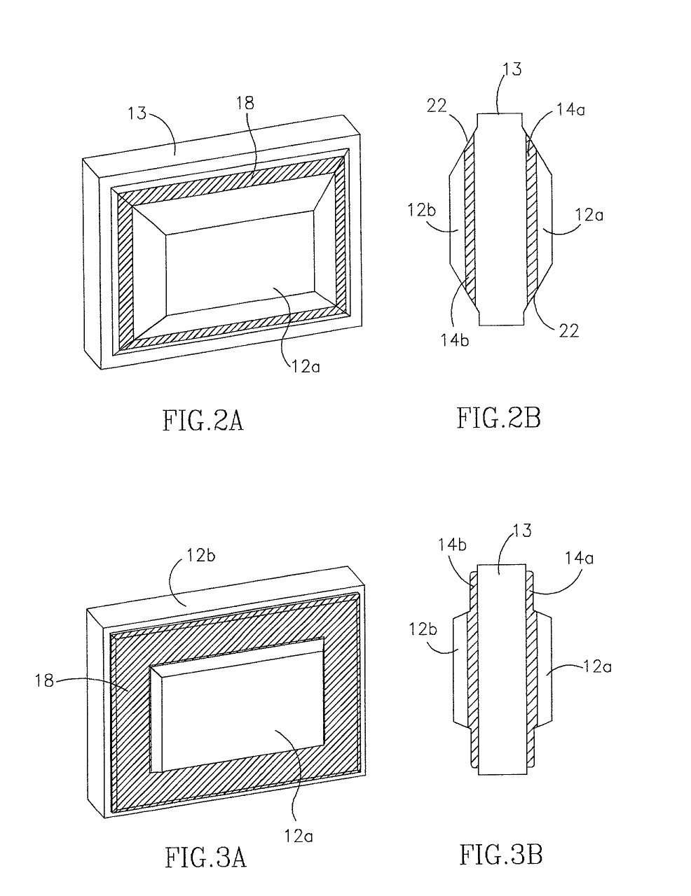

Referring now to FIGS. 2-4a and 2-4b, it may be seen that various forms of channels may be produced, by controlled variation of the depth, width and/or angle of cuts.

FIGS. 2a, b illustrate a pair of symmetrical cuts formed at an angle to the plane of the surfaces of layers 12 and 14. Sides 22 of each channel 18 are formed at a continuous incline, beginning from the outer surface of layers 12a and 12b, and continuing through metal layers 14a and 14b, so as to expose inner wooden layer 13.

FIGS. 3a,b illustrate an alternative channel formation, in which a pair of symmetrical channels 18 are formed so as to penetrate only a minimum depth of layers 14a and 14b, such that the channels pass through outer layers 12a and 12b to expose the flat outer surface of metal layers 14a and 14b, respectively. In this example, layer 13 is not exposed, so need not necessarily have the aesthetic properties of wood, but may be formed from any material having sufficient rigidity, such as fiberboard.

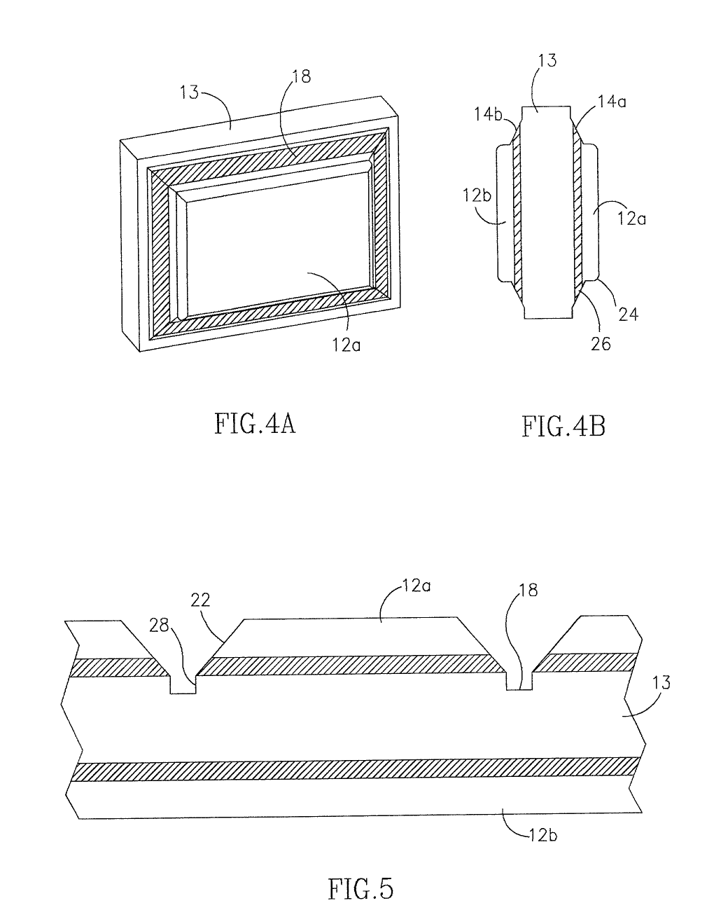

FIGS. 4a, b illustrate a further alternative channel formation, in which a pair of symmetrical channels 18 are formed using a shaped cutter bit, so as to form a channel having essentially straight edges 24 through outer layers 12a and 12b, and sloping edges 26 through layers 14a and 14b.

FIG. 5 illustrates a side view of a series of adjacent panels. In this example, cuts are made only in one outer wooden layer 12a, forming channels 18 in only one direction, such outer wooden layer 12b remains intact. Sides 22 of each channel 18 are formed at a continuous incline, beginning from the outer surface of layer 12a and continuing through metal layers 14a. The line of the cut further continues through inner wooden layer 13, such that sides 28 of channel 18 are at an angle perpendicular to the plane of layer 13.

The depth, width, shape and angle of sides of channel 18 may be varied, as required, by applying tools of different shape and dimensions, to produce the desired effect. The distances between adjacent channels 18 may also be varied in order to produce panels 20 of various dimensions, which need not necessarily be symmetrical.

The direction of channels 18 need not necessarily be arranged parallel to the edges of door 10, but may be diagonally oriented. Furthermore, by use of an appropriate control system, the cutting bit may used to produce any other required pattern of channels, such as circles, curves or specific designs. The cutting may be used to personalize a door with specific lettering, such as a family name for a door to a residential property, or a company name or logo for a commercial establishment. Similarly, the channels may be made in the form of specific numbers.

The depth of channel 18 may vary so as to expose metal layer 14a or 14b, or so as to continue through layers 14a and 14b and expose inner wooden layer 13.

The width of channel 18 may vary so as to produce a frame of desired thickness around each panel 20. The dimensions of channel 18 may even be equivalent to those of panels 20, such that raised wooden panels 20 are interspersed with flat metal panels.

The cutting process may be automated using a computerized numerical control work station, so as to increase the efficiency of the door production, reducing the time and labor involved and therefore reducing the overall cost of the process.

The door 10 of the present invention therefore has the aesthetic advantages of a raised panel wooden door, enhanced by metal edging around the panels, which is simple and quick to produce with a high level of symmetry in the panel arrangement, and has high durability, moisture-resistance, fire-resistance, sound insulating properties and increased security protection as compared to standard wooden raised panel doors.

The security and other aspects of door 10 are maintained when channels 18 are formed so as to expose aluminum layer 14, and are only minimally compromised when the channel 18 penetrates through layer 14.

Having described the invention with regard to certain specific embodiments thereof, it is to be understood that the description is not meant as a limitation, since further modifications will now suggest themselves to those skilled in the art, and it is intended to cover such modifications as fall within the scope of the appended claims.

I claim:

1. A wood and metal structure comprising:
a metal layer having a front surface and a back surface, and
an exterior wooden layer adhesively attached to said front surface of said metal layer,
wherein at least a portion of said wooden layer has said metal layer at least partially exposed by patterned cutting of channels in said wooden layer.

2. The structure of claim 1 further comprising a second exterior layer adhesively attached to said back surface of said metal layer.

3. The structure of claim 2 wherein said second exterior layer is formed from wood.

4. The structure of claim 1 further comprising:
at least a second metal layer having a front surface and a back surface;
at least a second exterior wooden layer adhesively attached to said front surface of said second metal layer; and
a rigid interior layer adhesively attached to said back surface of said first metal layer and said back surface of said second metal layer.

5. The structure of claim 4 wherein at least a portion of said second wooden layer has said second metal layer at least partially exposed by patterned cutting of channels in said second wooden layer.

6. The structure of claim 4 constructed as a door.

7. The structure of claim 1 wherein the depth of said channels is equal to that of said exterior wooden layer, such that said inner metal layer is exposed along the width of said channel.

8. The structure of claim 3 wherein said channels extend through said metal layer such that said second exterior wooden layer is exposed.

9. The structure of claim 4 wherein said rigid interior layer is formed from wood and wherein said channels extend through said metal layer such that said interior wooden layer is exposed.

10. The structure of claim 1 wherein said channels partially extend into said metal layer.

11. The structure of claim 1 wherein said metal layer comprises aluminum.

12. The structure of claim 1 wherein said channels are arranged in geometrical formation.

13. The structure of claim 1 wherein the distance between each pair of adjacent said channels is constant.

14. The structure of claim 1 wherein the distance between pairs of adjacent channels varies.

15. The structure of claim 1 wherein the width of said channels is less than the distance between adjacent channels.

16. The structure of claim 1 wherein the width of said channels is greater than the distance between adjacent channels.

17. The structure of claim 1 wherein the width of said channels is equal to the distance between adjacent channels.

18. The structure of claim 1 wherein said channels are formed in the shape of numbers.

19. The structure of claim 1 wherein said channels are formed in the shape of letters.

20. A method of constructing a decorative structure comprising:
providing a metal layer having a front surface and a back surface;
providing an exterior wooden layer;
adhesively attaching said wooden layer to said front surface of said metal layer; and
at least partially exposing a portion of said metal layer by patterned cutting of channels in said wooden layer.

21. The method of claim 19 wherein formation of said channels is performed with a jig cutting system to maintain constant depth.

22. The method of claim 20 wherein said jig cutting system is provided with at least one of manual and computerized numerical control systems.
